(19) United States
(12) Patent Application Publication
(10) Pub. No.: US 2026/0198527 A1
(43) Pub. Date: Jul. 16, 2026

(54) LINEAR MEAT-LIKE FOOD, MEAT-LIKE FOOD USING SAME, AND METHOD FOR PRODUCING SAME

(71) Applicant: Nisshin Seifun Group Inc., Tokyo (JP)

(72) Inventors: Masashi YOSHIDA, Fujimino-shi (JP); Nozomi SHATARI, Fujimino-shi (JP); Kenji NAKAMURA, Fujimino-shi (JP); Shinya TOKUDA, Fujimino-shi (JP); Noriyuki SHIBAMOTO, Fujimino-shi (JP)

(73) Assignee: Nisshin Seifun Group Inc., Tokyo (JP)

(21) Appl. No.: 19/134,987

(22) PCT Filed: Mar. 26, 2024
(86) PCT No.: PCT/JP2024/012106

§ 371 Date: Jun. 2, 2025

(30) Foreign Application Priority Data
Apr. 27, 2023 (JP) 2023-073695

(51) Int. Cl. A23J 3/26; A23J 3/14; A23J 3/22

(52) U.S. Cl. CPC A23J 3/26; A23J 3/14; A23J 3/227

(57) ABSTRACT

Fibrous meat-like food according to the present invention contains a vegetable protein, and has a moisture content of 40 mass % or more and a fiber thickness of 0.1 to 2.5 mm. One embodiment of the fibrous meat-like food of the present invention is obtained by extrusion molding a raw material that contains the vegetable protein. Meat-like food according to the present invention includes a densely integrated product of the fibrous meat-like food of the present invention. A method for producing meat-like food according to the present invention includes an integration step of densely integrating a raw material that contains the fibrous meat-like food. In the integration step, the raw material is subjected to vacuum packaging.

### TECHNICAL FIELD

The present invention relates to meat-like food that contains a vegetable protein and is useful as a meat substitute.

### BACKGROUND ART

Conventionally, vegetable proteins that are plant-derived proteins such as soybean protein and wheat protein are used as raw materials for processed food. In particular, in recent years, environmental load issues and the like caused by the increase in world population and livestock production have become major issues. As a solution, attention is given to processed food that can be used a substitute for livestock meat, and meat-like food composed mainly of a vegetable protein has been proposed as the processed food.

The meat-like food has a problem in that the textures are different from those of livestock meat. Patent Literature 1 discloses, as meat-like food for solving the problem, molded food that contains 100 parts by mass of a non-expanded extrusion molded body of a vegetable protein and 0.05 to 20 parts by mass of a binder such as transglutaminase. The non-expanded extrusion molded body can be obtained by extrusion molding a raw material that contains the vegetable protein using a known extrusion molding machine. The molded food is produced by mixing the non-expanded extrusion molded body obtained as described above and the binder, and molding the mixture into a desired shape. Patent Literature 1 does not mention the shape of the non-expanded extrusion molded body, and discloses that, from the viewpoint of easily mixing the non-expanded extrusion molded body with the binder, the non-expanded extrusion molded body is preferably sized such that the largest portion in size (long side) has a predetermined length (paragraph [0022] in Patent Literature 1).

Patent Literature 2 discloses beef/pork-like food that contains a vegetable protein, a moisturizing gel, and a coating film. The beef/pork-like food can be obtained by producing a texturized vegetable protein using an extruder, complexing the moisturizing gel with the vegetable protein, and then forming a coating film that coats them. The coating film is formed by immersing the vegetable protein to which the moisturizing gel has been complexed sequentially in a metal ion-containing aqueous solution and an aqueous solution in which a carbohydrate such as sodium alginate or pectin is dissolved. It is disclosed that the beef/pork-like food has a tactile sensation and a juicy texture similar to those of natural beef and pork.

### CITATION LIST

### Patent Literature

Patent Literature 1: JP 2023-2914A
Patent Literature 2: JP 2022-32495A

### SUMMARY OF INVENTION

It is an object of the present invention to provide meat-like food with textures close to those of livestock meat while containing a vegetable protein.

The present invention relates to fibrous meat-like food containing: a vegetable protein, wherein the fibrous meat-like food has a moisture content of 40 mass % or more, and a fiber thickness of 0.1 to 2.5 mm.

Also, the present invention relates to a method for producing fibrous meat-like food, wherein the fibrous meat-like food is the fibrous meat-like food of the present invention described above, using an extrusion machine that extrudes a raw material that contains the vegetable protein as an extrudate and a cooling die that is provided on a downstream side of the extrusion machine in an extrusion direction, internally includes a flow path through which the extrudate moves, and cools the extrudate that moves in the flow path, wherein a shredding unit is provided at a downstream end portion of the flow path of the cooling die in a moving direction of the extrudate, the shredding unit occupies at least a portion of a cross section of the flow path taken along a direction perpendicular to the moving direction, and includes a plurality of through holes that extend through the shredding unit in the moving direction, and the extrudate is shredded as a result of the extrudate passing through the plurality of through holes.

The present invention relates to meat-like food including: a densely integrated product of the fibrous meat-like food of the present invention described above.

Also, the present invention relates to a method for producing meat-like food, wherein the meat-like food is the meat-like food of the present invention described above, the method including: an integration step of densely integrating a raw material that contains the fibrous meat-like food. In the integration step, the raw material is subjected to vacuum packaging.

### BRIEF DESCRIPTION OF DRAWINGS

FIG. 1 is a cross-sectional view schematically showing a cross-section of a production apparatus that can be used to carry out a method for producing fibrous meat-like food of the present invention, taken along an extrusion direction.

FIG. 2 is a schematic view of a cross-section of a shredding unit included in the production apparatus shown in FIG. 1, taken along a direction perpendicular to the extrusion direction.

### DESCRIPTION OF EMBODIMENTS

The fibrous meat-like food of the present invention contains a vegetable protein. In the present invention, the term “vegetable protein” refers to a protein obtained from a plant. Examples of the source of supply of the vegetable protein include beans (soybeans, red beans, and the like), grains (wheat, barley, rice, corn, buckwheat, and the like), potatoes (yellow potatoes, and the like), seeds/nuts (peanuts, almonds, and the like), and algae. The vegetable protein may be treated with an enzyme or the like. In the fibrous meat-like food of the present invention, the above-listed vegetable proteins can be used alone or in a combination of two or more.

Examples of the vegetable protein suitable for use in the present invention include bean protein sourced from beans and grain protein sourced from grains (grain flours). Specific examples of the bean protein include soybean protein (for example, defatted soybean flour, concentrated soybean protein, isolated soybean protein, and extracted soybean protein), pea protein, fava bean protein, chickpea protein, and mung bean protein. Specific examples of the grain protein include wheat protein such as gluten, rice protein, oat protein, rapeseed protein, and potato protein.

From the viewpoint of more reliably achieving the object of providing meat-like food that is useful as a meat substitute, the content of the vegetable protein in the fibrous meat-like food of the present invention is, but is not particularly limited to, preferably 20 mass % or more, more preferably 60 mass % or more, or 100 mass % relative to the total mass of the fibrous meat-like food, or in other words, the fibrous meat-like food of the present invention may contain only the vegetable protein.

The fibrous meat-like food of the present invention may contain a component other than the vegetable protein as long as a predetermined advantageous effect of the present invention (providing meat-like food with textures close to those of livestock meat while containing a vegetable protein) is not inhibited. Examples of the component other than the vegetable protein include an animal protein, a starch, a polysaccharide, a dietary fiber, an edible fat/oil, a seasoning, a coloring agent, a flavoring agent, and an emulsifier. These can be used alone or in a combination of two or more. The term “animal protein” used herein refers to a protein that can be obtained from an animal. The animal protein may be sourced from, for example, meat, poultry, seafood, insects, eggs, and milk. The animal protein may be treated with an enzyme or the like. Also, the fibrous meat-like food of the present invention may contain a binder, which will be described later, as the other component.

The content of the component other than the vegetable protein in the fibrous meat-like food of the present invention is preferably 50 mass % or less, and more preferably 30 mass % or less relative to the total mass of the fibrous meat-like food.

The fibrous meat-like food of the present invention is required to have a moisture content of 40 mass % or more. When the moisture content of the fibrous meat-like food is less than 40 mass %, the fibrous meat-like food is too hard in texture, and thus the predetermined advantageous effect of the present invention may not be obtained. The term “moisture content” used herein refers to a value obtained through measurement in accordance with a complete dry method (of heating a measurement target to a product temperature of 130° C. and measuring a weight change before and after the heating).

From the viewpoint of more reliably achieving a predetermined advantageous effect of the present invention, the fibrous meat-like food of the present invention has a moisture content of preferably 40 to 95 mass %, and more preferably 50 to 80 mass %. When the moisture content of the fibrous meat-like food is too high, the fibrous meat-like food may have an excessively soft texture.

The moisture content of the fibrous meat-like food can be adjusted by adjusting the amount of water added to a raw material that contains the vegetable protein during production of the fibrous meat-like food.

The fibrous meat-like food of the present invention has fibers running in one direction. The fibrous meat-like food is required to have a fiber thickness of 0.1 to 2.5 mm. As used herein, the term “fiber thickness” refers to a maximum diameter of fibers in the fibrous meat-like food in a direction (hereinafter, also referred to as “width direction”) perpendicular to a lengthwise direction of the fibrous meat-like food. For example, in the case where the fibrous meat-like food has fibers with a circular cross-sectional shape as viewed in a direction along the width direction, the diameter of the circular shape is defined as the fiber thickness of the fibrous meat-like food. In the case where, for example, the fibrous meat-like food has fibers with a rectangular cross-sectional shape as viewed in a direction along the width direction, the length of a diagonal line of the rectangular shape is defined as the fiber thickness of the fibrous meat-like food.

When the fiber thickness of the fibrous meat-like food is less than 0.1 mm, the shape-retention ability of the fibrous meat-like food is lowered significantly, which compromises processing suitability, and it may be difficult to produce the meat-like food using the fibrous meat-like food. Also, when the fiber thickness of the fibrous meat-like food is greater than 2.5 mm, the meat-like food using the fibrous meat-like food may have poor textures (hardness, fibrous texture, and the like). From the viewpoint of more reliably achieving a predetermined advantageous effect of the present invention, the fibrous meat-like food of the present invention has a fiber thickness of preferably 0.2 to 2 mm, and more preferably 0.3 to 1 mm.

The cross-sectional shape of the fibrous meat-like food of the present invention as viewed in a direction along the width direction may be, but is not particularly limited to, for example, a circular shape, an elliptic shape, a triangular shape, a rectangular shape, a pentagonal shape, or a polygonal shape with more corners.

In the case where the fibrous meat-like food of the present invention has two or more diameters in a cross section as viewed in a direction along the width direction (for example, in the case where the cross-sectional shape of the fibrous meat-like food as viewed in a direction along the width direction is a rectangular shape), the minimum diameter of the fibrous meat-like food is preferably 0.1 to 2.5 mm, and more preferably 0.3 to 1 mm from the viewpoint of more reliably achieving a predetermined advantageous effect of the present invention.

The fibrous meat-like food of the present invention can be obtained by, typically, extrusion molding a raw material that contains the vegetable protein. That is, the fibrous meat-like food of the present invention may be fibrous meat-like food obtained by extrusion molding a raw material that contains the vegetable protein. The fibrous meat-like food of the present invention can be produced in accordance with an ordinary method using a known extrusion machine. The extrusion machine may be a uniaxial or biaxial extrusion machine, and may include a cooling die for cooling an extrudate.

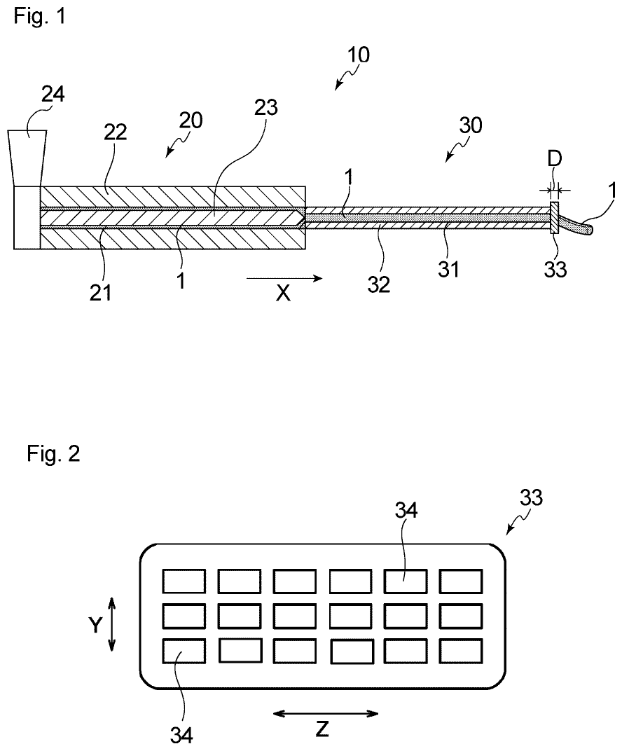

FIG. 1 shows a production apparatus 10 that is a production apparatus according to one embodiment and can be used in a method for producing fibrous meat-like food according to the present invention. The production apparatus 10 includes: an extrusion machine 20 that extrudes a raw material that contains the vegetable protein as an extrudate 1; and a cooling die 30 that is provided on the downstream side of the extrusion machine 20 in an extrusion direction X, internally includes a flow path 31 through which the extrudate 1 moves, and cools the extrudate 1 that moves through the flow path 31.

The extrusion machine 20 is configured basically in the same manner as a known extruder, and internally includes: a hollow cylindrical cylinder 22 that includes a flow path 21 through which the raw material flows; a screw 23 that is provided in the flow path 21, and rotated and driven by a driving source such as a motor; and a feeder 24 that supplies the raw material to the flow path 21. The flow path 21 extends in the same direction over the entire length of the cylinder 22 in the extrusion direction X. The extrusion machine 20 may include a heating means (not shown) such as a heater around the cylinder 22 so as to be capable of heating the extrudate 1 in the flow path 21. Also, the extrusion machine 20 may be configured such that steam can be introduced into the flow path 21. The extrusion machine 20 may be a uniaxial extrusion machine that includes one screw 23 or a biaxial extrusion machine that includes two screws 23.

The cooling die 30 internally includes a hollow cylindrical cylinder 32 that includes the flow path 31. The flow path 31 extends in the same direction over the entire length of the cylinder 32 in the extrusion direction X. The flow path 21 of the extrusion machine 20 is connected to the flow path 31 of the cooling die 30 such that the extrudate 1 in the flow path 21 is pushed by the screw 23 to flow into the flow path 31. In the embodiment shown, the moving direction of the extrudate 1 in the flow path 31 is the same direction as the extrusion direction X. In the cooling die 30, the extrudate 1 is cooled while moving through the flow path 31. The method for cooling the extrudate 1 in the cooling die 30 may be, but is not particularly limited to, for example, forced cooling that uses a cooling means, or natural cooling in which the extrudate 1 is simply moved through the flow path 31 in the moving direction X, without using a cooling means. The cooling die 30 may include, as the cooling means, a refrigerant flow path, such as a water jacket, provided around the cylinder 32.

A shredding unit 33 is provided at a downstream end portion of the flow path 31 of the cooling die 30 in the moving direction (extrusion direction X) of the extrudate 1. The shredding unit 33 occupies at least a portion of a cross section of the flow path 31 taken along a direction perpendicular to the extrusion direction X. In the present embodiment, as shown in FIG. 1, the shredding unit 33 has a flat plate shape, and occupies the entire cross section of the flow path 31 taken along the direction perpendicular to the extrusion direction X.

As shown in FIG. 2, the shredding unit 33 includes a plurality of through holes 34 that extend through the shredding unit 33 in the extrusion direction X. In the present embodiment, the shredding unit 33 has a direction Y perpendicular to the extrusion direction X, and a direction Z perpendicular to both the directions X and Y The plurality of through holes 34 are intermittently arranged in each of the directions Y and Z. The plurality of through holes 34 have the same shape and the same dimensions. As shown in FIG. 2, the plurality of through holes 34 have a rectangular shape (an elongated rectangular shape) as viewed in a plan view. In the present invention, the arrangement pattern of the through holes 34 in the shredding unit 34 (the shape, the dimensions, and the arrangement position of each through hole 34 as viewed in a plan view, the spacing between two adjacent through holes 34, and the number of through holes 34 per unit area) is not limited to that shown in FIG. 2, and can be set as appropriate as long as a predetermined advantageous effect of the present invention is not inhibited.

In the cooling die 30, the extrudate 1 in the flow path 31 is pushed by the screw 23 and introduced into the shredding unit 33, and shredded while passing through the plurality of through holes 34. Specifically, as a result of the extrudate 1, which is a lump with a shape corresponding to the internal shape of the flow path 31, being pushed toward the shredding unit 33 by the screw 23, the extrudate 1 is pushed out from each the plurality of through holes 34 in the form of fibers. Each of the plurality of fibers of the extrudate 1 that have passed through the through holes 34 of the shredding unit 33 is the fibrous meat-like food of the present invention. The fibrous meat-like food of the present invention obtained by extrusion molding a raw material that contains the vegetable protein as described above contains fibrous tissue with an orientation, and the fibers that constitute the fibrous tissue are oriented in the extrusion direction during extrusion molding.

As shown in FIG. 2, the dimensions of each through hole 34 of the shredding unit 33 as viewed in a plan view are closely related to the fiber thickness of the fibrous meat-like food produced after passing through the shredding unit 33. Usually, the shape and the dimensions of each through hole 34 as viewed in a plan view are reflected directly to the shape and the dimensions of the fibrous meat-like food. For this reason, it is preferable that the shape and the dimensions of each through hole 34 as viewed in a plan view are substantially matched to the shape and the dimensions as viewed in a cross section along the width direction of the intended fibrous meat-like food. Accordingly, from the viewpoint of adjusting the fiber thickness of the fibrous meat-like food (the maximum diameter of fibers of the fibrous meat-like food in the width direction) to 0.1 to 2.5 mm, the maximum diameter of each through hole 34 as viewed in a plan view is also preferably adjusted to 0.1 to 2.5 mm.

As shown in FIG. 2, the shredding unit 33 may be a porous structure obtained by forming through holes 34 in a plate-like member, or a mesh structure obtained by processing a linear material into the shape of a mesh such as weaving it into a plain fabric.

There is no particular limitation on the material of the shredding unit 33. For example, a metal such as iron, copper, titanium or stainless steel, a ceramic, or a resin may be used. The thickness D of the shredding unit 33 (see FIG. 1), or in other words, the length of the shredding unit 33 in the extrusion direction X is, from the viewpoint of the balance between the strength and the extrudability of the shredding unit 33, preferably 0.1 to 10 mm, and more preferably 1 to 5 mm.

In the method for producing fibrous meat-like food according to the present invention, typically, a mixture obtained by adding water to the raw material that contains the vegetable protein is extrusion molded. Specifically, the extrudate 1 shown in FIG. 2 is typically a mixture of the raw material that contains the vegetable protein and water. From the viewpoint of adjusting the moisture content of the fibrous meat-like food to 40 mass % or more as described above, and more reliably achieving a predetermined advantageous effect of the present invention, the amount of water added to the raw material is preferably 50 to 350 parts by mass, and more preferably 100 to 250 parts by mass relative to 100 parts by mass of the raw material (excluding water).

In the method for producing fibrous meat-like food according to the present invention, there is no particular limitation on the heating temperature of the raw material that contains the vegetable protein during extrusion molding. However, from the viewpoint of more reliably achieving a predetermined advantageous effect of the present invention, it is preferable to adjust a product temperature of the raw material at a downstream end of an extrusion machine used for extrusion molding in the extrusion direction to preferably 100 to 200° C., and more preferably 120 to 180° C. In the production apparatus 10, the term “product temperature” refers to a temperature of the extrudate 1 at a downstream end of the flow path 21 of the extrusion machine 20 in the extrusion direction X (a temperature of the extrudate 1 immediately before flowing into the flow path 31 of the cooling die 30).

In the method for producing fibrous meat-like food according to the present invention, there is no particular limitation on an extrusion pressure during extrusion molding of the raw material that contains the vegetable protein. However, from the viewpoint of more reliably achieving a predetermined advantageous effect of the present invention, it is preferable to adjust an extrusion pressure at a downstream end of an extrusion machine used for extrusion molding in the extrusion direction to preferably 0.5 to 10.0 MPa, and more preferably 1.0 to 5.0 MPa. In the production apparatus 10, the term “extrusion pressure” refers to an extrusion pressure at a downstream end of the flow path 21 of the extrusion machine 20 in the extrusion direction X (near the connecting portion between the extrusion machine 20 and the cooling die 30).

There is no particular limitation on a cooling temperature of the extrudate 1 by the cooling die 30. However, from the viewpoint of preventing the discharged material from expanding, it is preferable to adjust the product temperature of the extrudate 1 immediately after being pushed out from the cooling die 30, or in other words, the product temperature of the fibrous meat-like food immediately after production to preferably 20 to 90° C., and more preferably 40 to 70° C. Also, from the viewpoint of efficiently and reliably achieving the cooling temperature, the flow path 31 of the cooling die 30 has a length of preferably 300 to 2000 mm, and more preferably 50 to 1500 mm.

The fibrous meat-like food of the present invention may be subjected to a heat treatment such as retort sterilization for the purpose of sterilization or the like. Also, the fibrous meat-like food of the present invention can be refrigerated or stored frozen. The fibrous meat-like food of the present invention stored frozen is usually thawed before use.

The fibrous meat-like food of the present invention can be eaten as is without cooking, and can also be eaten after cooking such as grilling, deep frying, or steaming. Also, the fibrous meat-like food of the present invention can be used in various types of processed food. For example, the fibrous meat-like food of the present invention can be used as a raw material of processed food that does not contain livestock meat such as beef, pork, or chicken, thereby imparting, to the processed food, textures close to those of livestock meat. The processed food can be used as meat-like food that serves as a meat substitute. The fibrous meat-like food of the present invention can also be blended with processed food that contains livestock meat.

Next, meat-like food according to the present invention will be described. The meat-like food of the present invention contains a densely integrated product of the above-described fibrous meat-like food of the present invention, and is typically composed of the densely integrated product. The densely integrated product may contain a component other than the vegetable protein, such as a binder, which will be described later.

The densely integrated product has a configuration in which fibrous strands of the fibrous meat-like food of the present invention are closely attached to each other, and is typically, a lump in which a plurality of fibrous strands of the fibrous meat-like food are closely attached to each other, but may have a configuration in which a single fibrous strand of the fibrous meat-like food is folded to form a densely integrated product.

The meat-like food of the present invention may have the following configurations: a configuration (hereinafter also referred to as “first configuration”) in which fibrous strands of the fibrous meat-like food that constitute the densely integrated product are closely attached to each other in a random manner, and thus the fibrous strands of the fibrous meat-like food are uneven in the lengthwise direction of the fibrous meat-like food; and a configuration (hereinafter also referred to as “second configuration”) in which fibrous strands of the fibrous meat-like food that constitute the densely integrated product are even in the lengthwise direction of the fibrous meat-like food. Either one of them can be selected as appropriate according to the application or the like of the meat-like food. From the viewpoint of making the textures (fibrous texture, shredding texture, and the like) of the meat-like food much closer to those of livestock meat, the meat-like food preferably has the second configuration.

Regarding the meat-like food that has the first configuration, the fibrous meat-like food that constitutes the densely integrated product may or may not maintain its linear shape. In the case where the linear shape of the fibrous meat-like food that constitutes the densely integrated product is maintained, the resulting densely integrated product may have an external appearance similar to that of a noodle dough that is usually a lump of noodle strands. In the case where the linear shape of the fibrous meat-like food that constitutes the densely integrated product is not maintained, the resulting densely integrated product has an external appearance similar to that of a lump of ground meat that is usually made of livestock meat.

The meat-like food that has the first configuration can be obtained by, for example, stirring fibrous meat-like food, or a raw material obtained by adding a binder and the like, which will be descried later, to fibrous meat-like food. In the meat-like food that has the first configuration thus obtained, the degree at which the linear shape of the fibrous meat-like food is maintained can be adjusted by adjusting the degree of stirring.

Regarding the meat-like food that has the second configuration, the expression “fibrous strands of the fibrous meat-like food are even in the lengthwise direction” means that the angle formed by arbitrarily selected two fibrous strands that constitute the meat-like food in the lengthwise direction of the fibrous meat-like food is 45 degrees or less (the arbitrarily selected two fibrous strands including two fibrous strands formed by folding a single fibrous strand of the fibrous meat-like food, and the same applies hereinafter unless otherwise stated). As a result of the fibrous strands of the fibrous meat-like food that constitute the meat-like food being even in the lengthwise direction of the fibrous meat-like food, the fibers that constitute the fibrous tissue of the fibrous meat-like food are oriented in substantially one direction (the lengthwise direction of the fibrous meat-like food), and it is therefore possible to more reliably impart textures (fibrous texture, shredding texture, and the like) close to those of livestock meat to the meat-like food.

The meat-like food that has the second configuration can be obtained by, for example, making the fibrous strands of the fibrous meat-like food even in the lengthwise direction of the fibrous meat-like food (setting the angle formed by arbitrarily selected two fibrous strands of the fibrous meat-like food in the lengthwise direction to 45 degrees or less) when the fibrous strands of the fibrous meat-like food are densely integrated.

The fibrous meat-like food that constitute the meat-like food of the present invention may be composed of one type of fibrous meat-like food, or two or more types of fibrous meat-like food. In the case where the fibrous strands of the fibrous meat-like food to be compared have the same composition and fiber thickness, they are of the same type. In the case where the fibrous strands of the fibrous meat-like food to be compared have different compositions and fiber thicknesses, they are of different types.

A preferred example of the meat-like food of the present invention contains one or more types of fibrous meat-like food selected from the following items 1) to 3) (hereinafter, also referred to as “meat-like food A”). The meat-like food A is particularly useful as a meat substitute for chicken breast.
1) Fibrous meat-like food with a fiber thickness of 0.10 to 0.50 mm, preferably 0.15 to 0.45 mm, and more preferably 0.20 to 0.40 mm (hereinafter, also referred to as “fine fibrous meat-like food”).
2) Fibrous meat-like food with a fiber thickness of 0.51 to 0.74 mm, preferably 0.45 to 0.70 mm, and more preferably 0.50 to 0.65 mm (hereinafter, also referred to as “medium fibrous meat-like food”).
3) Fibrous meat-like food with a fiber thickness of 0.75 to 1.00 mm, preferably 0.80 to 0.95 mm, and more preferably 0.70 to 0.90 mm (hereinafter, also referred to as “thick fibrous meat-like food”).

As an example of the meat-like food A, the meat-like food A may contain two types of fibrous meat-like food including thick fibrous meat-like food and medium fibrous meat-like food as the fibrous meat-like food. In an example of the meat-like food A, the proportion of the thick fibrous meat-like food in the fibrous meat-like food is preferably 5 to 95 mass %, and more preferably 10 to 90 mass %, with the remaining fibrous meat-like food being the medium fibrous meat-like food.

As another example of the meat-like food A, the meat-like food A may contain two types of fibrous meat-like food including thick fibrous meat-like food and fine fibrous meat-like food. In an example of the meat-like food A, the proportion of the thick fibrous meat-like food in the fibrous meat-like food is preferably 5 to 95 mass %, and more preferably 10 to 90 mass %, with the remaining fibrous meat-like food being the fine fibrous meat-like food.

As yet another example of the meat-like food A, the meat-like food A may contain three types of fibrous meat-like food including thick fibrous meat-like food, medium fibrous meat-like food, and fine fibrous meat-like food as the fibrous meat-like food. In an example of the meat-like food A, the proportion of the thick fibrous meat-like food in the fibrous meat-like food is preferably 10 to 90 mass %, and more preferably 20 to 80 mass %. The proportion of the medium fibrous meat-like food in the fibrous meat-like food is preferably 10 to 90 mass %, and more preferably 20 to 80 mass %, with the remaining fibrous meat-like food being the fine fibrous meat-like food.

The meat-like food of the present invention may contain a binder for binding the fibrous strands of the fibrous meat-like food. As a result of containing the binder, the degree of integration of the fibrous strands of the fibrous meat-like food that constitute the meat-like food is enhanced, and the processing suitability of the meat-like food can be further improved. Examples of the binder include a vegetable protein, a starch, a polysaccharide thickener, egg white powder, whole egg powder, a milk protein, gelatin, agar, methylcellulose, hydroxypropyl methylcellulose, and transglutaminase. These binders can be used alone or in a combination of two or more. Examples of the vegetable protein (binder) include isolated soybean protein, concentrated soybean protein, soy milk powder, defatted soybean flour, full-fat soybean flour, and wheat protein (gluten). Examples of the starch (binder) include: unmodified starches such as potato starch, corn starch, tapioca starch, sago starch, and wheat flour starch; and modified starches obtained by subjecting an unmodified starch to one or more processing operations such as oil/fat processing, etherification, esterification, acetylation, crosslinking, and oxidation. Examples of the polysaccharide thickener (binder) include xanthan gum, guar gum, locust bean gum, carrageenan, and alginic acid. Among the above-listed binders, in particular, it is preferable to use transglutaminase that is a type of enzyme.

The amount of the binder contained in the meat-like food of the present invention is preferably 0.5 to 50 parts by mass, and more preferably 1 to 30 parts by mass relative to 100 parts by mass of the vegetable protein in the meat-like food.

The meat-like food of the present invention may contain a component other than the fibrous meat-like food and the binder as long as a predetermined advantageous effect of the present invention (providing meat-like food with textures close to those of livestock meat while containing a vegetable protein) is not inhibited. Examples of the component other than the fibrous meat-like food and the binder include a starch, a polysaccharide, a dietary fiber, an edible fat/oil, a seasoning, a coloring agent, a flavoring agent, and an emulsifier. These can be used alone or in a combination of two or more. The amount of the component other than the vegetable protein in the meat-like food of the present invention is preferably 10 mass % or less, and more preferably 5 mass % or less relative to the total mass of the meat-like food.

The meat-like food of the present invention may include a coating film that covers the densely integrated product. With the presence of the coating film, the shape-retention ability of the meat-like food is further improved in synergy with the shape-retention ability improving effect produced by the fibrous meat-like food of the present invention, and the meat-like food has excellent processing suitability. Also, with the presence of the coating film, moisture reduction while heat cooking the meat-like food is suppressed, which increases the juicy texture of the meat-like food and the hardness of the meat-like food, which may make the textures of the meat-like food much closer to those of livestock meat.

The coating film is composed mainly of a coating film material. The amount of the coating film material in the coating film is usually 0.5 mass % or more relative to the total mass of the coating film, and may be 100 mass %, or in other words, the entire coating film may be composed only of the coating film material.

Examples of the coating film material include: carbohydrates such as sodium alginate, potassium alginate, calcium alginate, agar, and konnyaku (a jelly-like ingredient made from konjac); metal ions such as sodium ions, calcium ions, magnesium ions, and aluminum ions; polysaccharide thickeners such as carrageenan (κ-type, t-type, λ-type), gellan gum, pectin, and xanthan gum; a vegetable protein; and a starch. These can be used alone or in a combination of two or more. The metal ions have the function of, upon coming into contact with a carbohydrate, enabling the carbohydrate to coagulate to facilitate formation of the coating film. As the vegetable protein, the starch, and the polysaccharide thickeners, those that can be used as the binder can be used.

The coating film has a thickness of preferably 1 to 3000 μm, and more preferably 1 to 1000 μm. There is no particular limitation on the method for forming the coating film. The coating film can be formed in accordance with a conventionally known method for forming a coating film on food. For the coating film, the technique disclosed in Patent Literature 2 can be used as appropriate.

A method for producing meat-like food of the present invention includes an integration step of densely integrating a raw material that contains the fibrous meat-like food. The expression “a raw material that contains the fibrous meat-like food” may encompass a raw material that contains only fibrous meat-like food and a raw material that contains the fibrous meat-like food and a component (for example, a binder) other than the fibrous meat-like food.

The integration step can be carried out by densely gathering together a raw material that contains the fibrous meat-like food, and optimally molding the raw material into a desired shape. The raw material can be densely gathered by using, for example, a method in which a plurality of fibrous strands of fibrous meat-like food are gathered to be in contact with each other, or a method in which a single fibrous strand of fibrous meat-like food is folded one or more times.

In the integration step, a raw material that contains the fibrous meat-like food is preferably compression molded. As a result of the raw material being compression molded, the shape-retention ability of finally obtained meat-like food can be further improved. As an example of the compression molding, a method may be used in which the raw material that contains the fibrous meat-like food is stirred. Typically, the raw material can be stirred by stirring the entire raw material that contains the fibrous meat-like food manually or using a device such as a stirrer. As another example of the compression molding, a raw material that contains the fibrous meat-like food may be compressed using a known compressing means such as a pressing machine.

The compression molding may be performed in a normal pressure environment (at a pressure of 1 atmosphere), or reduced pressure environment (including vacuum). As a specific example of the latter, the raw material that contains the fibrous meat-like food may be subjected to vacuum packaging. The raw material to be subjected to vacuum packaging may be obtained by compression molding the raw material that contains the fibrous meat-like food through stirring or compression using a pressing machine, or in other words, it may be a raw material that has already been densely integrated. The vacuum packaging can be carried out in accordance with a conventional method. Typically, the vacuum packaging can be carried out by placing the raw material that contains the fibrous meat-like food in a packaging container, then removing the air in the packaging container through suction for degassing to bring the packaging container into a vacuum state, and hermetically sealing the packaging container. As a result of the raw material that contains the fibrous meat-like food being subjected to vacuum packaging, the entire raw material is appropriately compressed by the packaging container, and thus the raw material is densely integrated, and the degree of dense integration is enhanced in the case where the raw material has already been densely integrated by stirring or the like. By vacuum packaging the raw material that contains the fibrous meat-like food, it is possible to obtain meat-like food that has excellent shape-retention ability, without a binder being contained in the raw material.

As the degree of vacuum used for the vacuum packaging, from the viewpoint of the balance between the processing suitability and the textures of the meat-like food, the degree of vacuum is preferably 50 to 100%, and more preferably 80 to 98%, where the absolute vacuum is 100% and the atmospheric pressure is 0%. As the packaging container, any packaging container can be used as long as the packaging container is made of a gas-barrier material that can be used for vacuum packaging. For example, a pouch container made of a synthetic resin may be used.

From the viewpoint of forming the meat-like food into a desired shape through the vacuum packaging, the raw material to be placed in the packaging container may be packed into a mold whose shape conforms to the desired shape, the mold may be placed in the packaging container, and then the packaging container may be brought into a vacuum state.

In the case where a binder is contained in the raw material of the meat-like food, in the integration step, it is preferable to attach the binder to the surface of fibrous meat-like food, and then densely integrate the fibrous meat-like food. In this case, the binder attached to the surface of fibrous meat-like food is preferably in the form of a powder at a normal temperature and pressure (at an atmospheric temperature of 20° C. and a pressure of 1 atmosphere) from the viewpoint of ease of handling and the like.

For example, when producing the meat-like food that has the first configuration, it is possible to use a step of dispersing a powder binder onto the surface of fibrous meat-like food and then compression molding the fibrous meat-like food through stirring or compression using a pressing machine.

Also, when producing the meat-like food that has the second configuration, it is possible to use a step of aligning a plurality of fibrous strands of the fibrous meat-like food or a single fibrous strand of the fibrous meat-like food that has been folded, such that the fibrous strands are even in the lengthwise direction (the angle formed by arbitrarily selected two fibrous strands of the fibrous meat-like food in the lengthwise direction is 45 degrees or less), and then dispersing a powder binder onto the surfaces of the fibrous strands of the fibrous meat-like food that have been aligned. As in an integration method B, which will be described later, the series of operations of aligning the fibrous strands of the fibrous meat-like food and then dispersing the binder may be repeated a plurality of times.

In the integration step, the raw material that contains the fibrous meat-like food may be optionally subjected to a heat treatment. It is preferable to perform a heat treatment particularly when the raw material contains an enzyme (transglutaminase or the like), a polysaccharide thickener (xanthan gum or the like), a protein (soybean protein or the like), a starch (any type of modified starch or the like) as the binder. Through the heat treatment, the enzyme used as the binder is deactivated, the polysaccharide thickener used as the binder has an increased viscosity, the protein used as the binder is coagulated by heating, and the starch used as the binder is gelatinized. As a result, the shape-retention ability and the textures of the finally obtained meat-like food can be further improved.

There is no particular limitation on the timing at which the heat treatment is carried out. Typically, the raw material that contains the fibrous meat-like food is subjected to the heat treatment after the raw material is densely integrated through compression molding or the like. However, the raw material may be subjected to the heat treatment heat before or during densely integrating the raw material.

There is no particular limitation on the heat treatment conditions (heating temperature and heating time), and the heat treatment conditions may be adjusted as appropriate according to the type of binder used.

For example, in the case where the binder contains one or more selected from an enzyme, a polysaccharide thickener, a protein, and a starch, the heating temperature (the product temperature of the raw material that contains the fibrous meat-like food) is preferably 60 to 100° C., and more preferably 70 to 100° C. The heating time during which the product temperature is maintained is preferably 1 to 30 minutes, and more preferably 2 to 20 minutes.

In the case where the intended meat-like food includes a coating film as described above, a step of forming the coating film is performed after the integration step. The method for producing meat-like food of the present invention may include a coating film forming step after the integration step.

As an example of the coating film forming step, a step of immersing the densely integrated product of the fibrous meat-like food obtained in the integration step in a liquid that contains the coating film material (a coating film material liquid), and then drying the densely integrated product as needed may be included. The process of immersing the densely integrated product in the coating film material liquid may be performed a plurality of times. Specifically, for example, the densely integrated product may be immersed in a liquid that contains the carbohydrate (the coating film material) and a liquid that contains the metal ions (the coating film material) in this order or a reverse order.

As another example of the coating film forming step, a step of attaching, to the surface of the densely integrated product, one or more coating film materials in the form of powders selected from a vegetable protein, a starch, and a polysaccharide thickener, then immersing the densely integrated product in water, and subjecting the densely integrated product to a heat treatment may be included.

The amount of the coating film materials used in the coating film forming step is preferably 0.1 to 10 parts by mass, and more preferably 0.1 to 5 parts by mass relative to 100 parts by mass of the densely integrated product.

### EXAMPLES

Hereinafter, the present invention will be described in further detail based on examples. However, the present invention is not limited to the examples given below.

### Production of Fibrous Meat-Like Food

Fibrous meat-like foods A to F were produced by extrusion molding a mixture prepared by adding water to a raw material that contains a vegetable protein. The production conditions and the characteristics of the fibrous meat-like foods A to F are shown in Table 1 given below.

The production apparatus used to produce the fibrous meat-like foods A to F had the same basic configuration as that of the production apparatus 10 described above (see FIG. 1), and included a biaxial extrusion machine and a cooling die connected to the biaxial extrusion machine. When producing the fibrous meat-like foods B to F, any one of shredding units a to c shown below was provided at a downstream end of the flow path of the cooling die in the extrusion direction. Each of the shredding units a to c shown below was a mesh structure (with a thickness of 1 mm) formed by weaving a metal wire material into a mesh plain fabric.

Details of the raw material and the conditions for extrusion molding are shown below.

### Raw Material

Soybean protein (vegetable protein): Fuji Pro CA, with an anhydrous equivalent protein content of 90 mass % or more, available from Fuji Oil Co., Ltd.
Wheat protein (vegetable protein): WEIPRO, with an anhydrous equivalent protein content of 72 mass % or more, available from Jäckering Mühlen-und Nährmittelwerke GmbH

### Conditions for Extrusion Molding

Heating temperature (the product temperature of the raw material at the downstream end of the extrusion machine in the extrusion direction): 140 to 180° C.
Extrusion pressure (the extrusion pressure at the downstream end of the extrusion machine in the extrusion direction): 1.0 to 5.0 MPa
Cooling temperature: adjusted such that the product temperature of the extrudate (fibrous meat-like food) immediately after pushed out from the cooling die was 80° C.
Shredding unit a: 20 mesh, a wire material diameter of 0.25 mm, and an aperture size of 0.78 mm
Shredding unit b: 30 mesh, a wire material diameter of 0.18 mm, and an aperture size of 0.60 mm
Shredding unit c: 40 mesh, a wire material diameter of 0.15 mm, and an aperture size of 0.42 mm

TABLE 1

| | | Fibrous meat-like food | | | | | |
|---|---|---|---|---|---|---|---|
| | | A | B | C | D | E | F |
| Production | Production method | Extrusion | Extrusion | Extrusion | Extrusion | Extrusion | Extrusion |
| conditions | | molding | molding | molding | molding | molding | molding |
| | Shredding unit used in | — | a | b | c | a | b |
| | extrusion molding | | | | | | |
| | Amount of water added relative | 140 | 140 | 140 | 140 | 50 | 50 |
| | to 100 parts by mass of raw | | | | | | |
| | material (part by mass) | | | | | | |
| Characteristics | Moisture content (mass %) | 58 | 58 | 58 | 58 | 50 | 50 |
| | Content of vegetable protein | 100 | 100 | 100 | 100 | 100 | 100 |
| | (mass %) | | | | | | |
| | Cross-sectional shape taken | Rectangular | Rectangular | Rectangular | Rectangular | Rectangular | Rectangular |
| | along width direction | | | | | | |
| | Fiber thickness^{*1} (mm) | 35-66 | 0.78 | 0.60 | 0.42 | 0.78 | 0.60 |

^{*1}Maximum diameter of fibers of the fibrous meat-like food in the width direction.

### Examples 1 to 21 and Comparative Example 1

Meat-like foods that serve as meat substitutes for chicken breast were produced using the fibrous meat-like foods A to F. Specifically, meat-like food was produced by densely integrating a raw material containing one or more of the fibrous meat-like foods A to F in accordance with any one of the following integration methods A to G. In the integration methods A to G, the integration method B is a method for obtaining meat-like food of the second configuration, and the other methods are methods for obtaining meat-like food of the first configuration.
Integration method A: manually stirring an entire raw material containing fibrous meat-like food (also containing a binder when using the binder, and the same applies hereinafter), packing the stirred mixture into a mold, placing the mold in a sealable zipper bag, subjecting the mold to a heat treatment, and then leaving the mold to cool naturally at a normal temperature for 30 minutes.
Integration method B: repeating, a plurality of times, a series of operations of aligning fibrous strands of fibrous meat-like food and dispersing a binder. Specifically, first, the bottom of a mold was covered with fibrous meat-like food such that a plurality of fibrous strands of the fibrous meat-like food were even in the lengthwise direction, so as to align the plurality of fibrous strands of the fibrous meat-like food. After that, a binder was uniformly dispersed onto the entire upper surface of the fibrous meat-like food whose fibrous strands were aligned (a first operation). Next, different fibrous meat-like food was aligned on the surface of the fibrous meat-like food to which the binder had been dispersed such that a plurality of fibrous strands of the different fibrous meat-like food were even in the lengthwise direction. After that, a binder was uniformly dispersed onto the entire upper surface of the different fibrous meat-like food (a second operation). After the second operation was repeated one or more times, the mold was placed in a sealable zipper bag and subjected to a heat treatment, and then left to cool naturally at a normal temperature for 30 minutes.
Integration method C: The method includes packing a raw material containing fibrous meat-like food into a mold and compressing the raw material in the thickness direction at a pressure of 0.3 MPa for 5 seconds using a pressing machine (MS1-100 available from Riken Seiki).
Integration method D: The method is the same as the integration method C, except that the pressure applied by the pressing machine was changed to 0.1 MPa, and the compression time was changed to 1 second.
Integration method E: The method includes manually stirring an entire raw material containing fibrous meat-like food, packing the stirred mixture into a mold, placing the mold in a sealable zipper bag, vacuum packaging the mold at a degree of vacuum of 90% using a vacuum packaging machine (Z3000 available from Fujimak Corporation), subjecting the vacuumed package to a heat treatment, and then leaving the vacuumed package to cool naturally at a normal temperature for 30 minutes.
Integration method F: The method is the same as the integration method E, except that the degree of vacuum was changed to 95%.
Integration method G: The method is the same as the integration method E, except that the degree of vacuum was changed to 98%.

In the production of the fibrous meat-like foods A to F, as the mold used in the integration method, a bottomed plastic tray with an open top was used. The tray had an elliptic shape with a length in the short axis direction of 7 cm and a length in the long axis direction of 10 cm as viewed in a plan view (as viewed from above), and had a depth of 2 cm.

Details of the binders used in the production of the fibrous meat-like foods A to F and the heat treatment performed in the integration step are shown below. The binders used were powders at a normal temperature and pressure (at an atmospheric temperature of 20° C., at a pressure of 1 atmosphere).
Binder A: Transglutaminase (the heating temperature was set to 95° C. and the heating time was set to 5 minutes in the heat treatment)
Binder B: Xanthan gum (the heating temperature was set to 95° C. and the heating time was set to 5 minutes in the heat treatment)
Binder C: Guar gum (the heating temperature was set to 95° C. and the heating time was set to 5 minutes in the heat treatment)
Binder D: Soybean protein (the heating temperature was set to 95° C. and the heating time was set to 5 minutes in the heat treatment)
Binder E: Wheat protein (the heating temperature was set to 95° C. and the heating time was set to 5 minutes in the heat treatment)
Binder F: Etherified tapioca starch (the heating temperature was set to 95° C. and the heating time was set to 5 minutes in the heat treatment)
Binder G: Wheat flour starch (the heating temperature was set to 95° C. and the heating time was set to 5 minutes in the heat treatment)
Binder H: A mixture of transglutaminase, a wheat protein, and a wheat flour starch mixed at a ratio of 1:5:5 (the heating temperature was set to 95° C. and the heating time was set to 5 minutes in the heat treatment)

### Examples 22 to 26

In each example, meat-like food was produced in the same manner as in Example 21, except that, after the raw material containing fibrous meat-like food was integrated to form a densely integrated product, and the densely integrated product of the fibrous meat-like food obtained in the integration step was subjected to the coating film forming step to form a coating film on the entire surface of the densely integrated product. In the coating film forming step, either one of the following coating film forming methods A and B was used. The coating film of the produced meat-like food had a thickness of 1000 to 2000 μm.

### Coating Film Forming Method A

An aqueous solution of sodium alginate (coating film material liquid A) containing 1 mass % of sodium alginate (coating film material A) and an aqueous solution of calcium lactate (coating film material liquid B) containing 10 mass % of calcium lactate (coating film material B) were prepared. An entire processing target (densely integrated product) was immersed in the coating film material liquid A, and then immersed in the coating film material liquid B.

### Coating Film Forming Method B

Any one the following coating film materials C to E in the form of powders was attached to the entire surface of a processing target (densely integrated product), and then the entire processing target was immersed in water. Next, the processing target was heated in an oven. In the heat treatment, the heating temperature was set to 160° C. and the heating time was set to 5 minutes irrespective of which one of the coating film materials C to E was used.
Coating film material C: Vegetable protein (Nutralys F85M available from Roquette Japan K.K.)
Coating film material D: Starch (corn starch Seiun 500 available from Oji Cornstarch Co. Ltd.)
Coating film material E: Starch (corn starch Batter Light T available from Oji Cornstarch Co. Ltd.)

### Evaluation Tests

Each meat-like food to be evaluated was heat cooked, and the shape-retention ability of the meat-like food was evaluated based on the following evaluation criteria by 10 expert panelists. The meat-like food was heat cooked (deep fried) in the following procedure. Specifically, fried meat-like food was made by placing the meat-like food and a seasoning liquid in a gas-barrier pouch container, leaving it for 30 minutes, with the entire meat-like food being immersed in the seasoning liquid, after that, taking the meat-like food out of the gas-barrier pouch container, removing an excess of the seasoning liquid from the meat-like food, sprinkling coating flour to the surface of the meat-like food, battering the meat-like food, and deep frying the meat-like food in oil heated to 180° C. for 1.5 minutes.

The cooked meat-like food (fried meat-like food) obtained by heat cooking the meat-like food was eaten and the textures (hardness, fibrous texture, and shredding texture) of the cooked meat-like food was evaluated based on the following evaluation criteria by 10 expert panelists. The results (the arithmetic average value of evaluation points from the 10 expert panelists) are shown in Tables 2 to 4 given below.

### Evaluation Criteria for Shape-Retention Ability

5 points: Very good. The meat-like food did not lose its shape at all during cooking (95% or more of the entire meat-like food retained its shape)
4 points: Good. The meat-like food hardly lost its shape during cooking (90% or more and less than 95% of the entire meat-like food retained its shape)
3 points: Acceptable. The meat-like food slightly lost its shape during cooking (85% or more and less than 90% of the entire meat-like food retained its shape).
2 points: Poor. The meat-like food lost its shape during cooking (80% or more and less than 85% of the entire meat-like food retained its shape).
1 point: Very poor. The meat-like food completely lost its shape during cooking (less than 80% of the entire meat-like food retained its shape).

### Evaluation Criteria for Textures (Hardness, Fibrous Texture, and Shredding Texture)

The textures (hardness, fibrous texture, and shredding texture) of the cooked meat-like food were evaluated based on the following evaluation criteria. The term “fibrous texture” refers to a texture of fibers derived from the muscle fibers of livestock meat. The term “shredding texture” refers to a feeling of collapsing the meat-like food (the shredding texture of constituent fibers) that can be perceived in three quarters of the chewing time of the meat-like food (the time from when the meat-like food was put into the mouth to when the meat-like food was swallowed), excluding the last one quarter.
5 points: Very good. The textures were very close to those of livestock meat (chicken breast).
4 points: Good. The textures were close to those of livestock meat (chicken breast).
3 points: Acceptable. The textures were somewhat close to those of livestock meat (chicken breast).
2 points: Poor. The textures were different from those of livestock meat (chicken breast).
1 point: Very poor. The textures were much different from those of livestock meat (chicken breast).

TABLE 2

| | | Comp. | | | | | | |
|---|---|---|---|---|---|---|---|---|
| | | Example. | Example | | | | | |
| | | 1 | 1 | 2 | 3 | 4 | 5 | 6 |
| Fibrous meat- | A | 100 | — | — | — | — | — | — |
| like food (part | B | — | 100 | — | — | 50 | 50 | — |
| by mass) | C | — | — | 100 | — | 50 | — | 50 |
| | D | 1 | — | — | 100 | — | 50 | 50 |
| Binder (part by | A | 2 | 2 | 2 | 2 | 2 | 2 | 2 |
| mass^{*1}) | B | — | — | — | — | — | — | — |
| | C | — | — | — | — | — | — | — |
| | D | — | — | — | — | — | — | — |
| | E | — | — | — | — | — | — | — |
| | F | — | — | — | — | — | — | — |
| | G | — | — | — | — | — | — | — |
| Method for integrating fibrous | | A | A | A | A | A | A | A |
| meat-like food | | | | | | | | |
| Evaluation of | Shape retention | 1.0 | 4.0 | 4.0 | 4.0 | 4.0 | 4.0 | 4.0 |
| meat-like food | ability | | | | | | | |
| (Out of 5 | Hardness | 1.0 | 2.0 | 3.0 | 3.0 | 3.0 | 2.5 | 3.0 |
| points) | Fibrous texture | 1.0 | 4.0 | 3.0 | 2.0 | 3.5 | 3.5 | 2.5 |
| | Shredding | 1.0 | 4.0 | 3.0 | 2.5 | 4.0 | 3.5 | 3.0 |
| | texture | | | | | | | |
| | | Example | | | | | | |
| | | 7 | 8 | 9 | 10 | 11 | 12 | 13 |
| Fibrous meat- | A | — | — | — | — | — | — | — |
| like food (part | B | 34 | 50 | 50 | 50 | 50 | 50 | 50 |
| by mass) | C | 33 | 50 | 50 | 50 | 50 | 50 | 50 |
| | D | 33 | — | — | — | — | — | — |
| Binder (part by | A | 2 | — | — | — | — | — | — |
| mass^{*1}) | B | — | 0.3 | — | — | — | — | — |
| | C | — | — | 0.3 | — | — | — | — |
| | D | — | — | — | 10 | — | — | — |
| | E | — | — | — | — | 10 | — | — |
| | F | — | — | — | — | — | 10 | — |
| | G | — | — | — | — | — | — | 10 |
| Method for integrating fibrous | | A | A | A | A | A | A | A |
| meat-like food | | | | | | | | |
| Evaluation of | Shape retention | 4.0 | 3.5 | 3.5 | 3.2 | 4.2 | 4.2 | 4.2 |
| meat-like food | ability | | | | | | | |
| (Out of 5 | Hardness | 3.0 | 3.0 | 3.0 | 3.0 | 3.0 | 3.0 | 3.0 |
| points) | Fibrous texture | 3.7 | 3.5 | 3.5 | 3.5 | 3.5 | 3.2 | 3.2 |
| | Shredding | 3.0 | 4.2 | 4.2 | 4.3 | 3.6 | 3.0 | 3.4 |
| | texture | | | | | | | |

^{*1}Amount relative to 100 parts by mass of the vegetable protein in the meat-like food.

As shown in Table 2, the meat-like foods of Examples were produced using the fibrous meat-like foods B to D with a fiber thickness of 0.1 to 2.5 mm, and thus the meat-like foods were excellent in terms of shape-retention ability and textures, as compared with the meat-like food of Comparative Example produced without using them.

TABLE 3

| | | Example | | | | | | | | |
|---|---|---|---|---|---|---|---|---|---|---|
| | | 4 | 14 | 15 | 16 | 17 | 18 | 19 | 20 | 21 |
| Fibrous meat-like | B | 50 | 50 | 50 | 50 | 50 | 50 | 50 | 50 | — |
| food | C | 50 | 50 | 50 | 50 | 50 | 50 | 50 | 50 | — |
| (part by mass) | E | — | — | — | — | — | — | — | — | 50 |
| | F | — | — | — | — | — | — | — | — | 50 |
| Binder | A | 2 | — | — | — | — | — | — | — | — |
| (part by mass^{*1}) | H | — | — | — | — | — | — | 22 | 22 | 22 |
| Method for integrating fibrous | | A | C | D | E | F | G | F | B | B |
| meat-like food | | | | | | | | | | |
| Evaluation of | Shape | 4.0 | 4.3 | 4.5 | 3.0 | 3.9 | 4.5 | 4.5 | 4.5 | 4.5 |
| meat-like food | retention | | | | | | | | | |
| (Out of maximum of | ability | | | | | | | | | |
| 5 points) | Hardness | 3.0 | 2.8 | 2.5 | 3.3 | 3.3 | 2.7 | 3.3 | 3.7 | 3.7 |
| | Fibrous | 3.5 | 3.3 | 3.1 | 3.7 | 3.9 | 3.0 | 3.9 | 4.2 | 4.6 |
| | texture | | | | | | | | | |
| | Shredding | 4.0 | 3.7 | 3.3 | 3.8 | 3.7 | 2.8 | 4.0 | 4.2 | 4.2 |
| | texture | | | | | | | | | |

^{*1}Amount relative to 100 parts by mass of the vegetable protein in the meat-like food.

TABLE 4

| | | Example | | | | | |
|---|---|---|---|---|---|---|---|
| | | 21 | 22 | 23 | 24 | 25 | 26 |
| Fibrous meat-like | E | 50 | 50 | 50 | 50 | 50 | 50 |
| food | | | | | | | |
| (part by mass) | F | 50 | 50 | 50 | 50 | 50 | 50 |
| Binder H (part by mass^{*1}) | | 22 | 22 | 22 | 22 | 22 | 22 |
| Method for integrating fibrous | | B | B | B | B | B | B |
| meat-like food | | | | | | | |
| Coating film | | Not | Formed | Formed | Formed | Formed | Formed |
| | | formed | | | | | |
| Coating film | A | — | 2 | — | — | — | — |
| material | B | — | 2 | — | — | — | — |
| (part by mass^{*2}) | C | — | — | 3 | — | — | 1.5 |
| | D | — | — | — | 3 | — | 1.5 |
| | E | — | — | — | — | 3 | — |
| Evaluation of | Shape | 4.5 | 4.9 | 4.8 | 4.8 | 4.8 | 4.9 |
| meat-like food | retention | | | | | | |
| (Out of 5 points | ability | | | | | | |
| of maximum) | Hardness | 3.7 | 4.2 | 4.0 | 4.0 | 4.0 | 4.1 |
| | Fibrous | 4.6 | 4.6 | 4.6 | 4.6 | 4.6 | 4.6 |
| | texture | | | | | | |
| | Shredding | 4.2 | 4.2 | 4.2 | 4.2 | 4.2 | 4.2 |
| | texture | | | | | | |

^{*1}Amount relative to 100 parts by mass of the vegetable protein in the meat-like food.
^{*2}Amount relative to 100 parts by mass of the densely integrated product in the fibrous meat-like food.

### INDUSTRIAL APPLICABILITY

The fibrous meat-like food of the present invention has a high shape-retention ability and excellent processing suitability, and is therefore suitable for use as a raw material of meat-like food that serves as a meat substitute. The meat-like food of the present invention is produced using the fibrous meat-like food of the present invention as the raw material, and thus has textures (specifically, hardness, fibrous texture, and the like) close to those of livestock meat such as beef, pork, and chicken while containing a vegetable protein.

1. Fibrous meat-like food comprising a vegetable protein,
wherein the fibrous meat-like food has a moisture content of 40 mass % or more, and a fiber thickness of 0.1 to 2.5 mm.

2. The fibrous meat-like food according to claim 1,
wherein the fibrous meat-like food is obtained by extrusion molding a raw material that contains the vegetable protein.

3. A method for producing fibrous meat-like food, wherein the fibrous meat-like food is according to claim 1, using an extrusion machine that extrudes a raw material that contains the vegetable protein as an extrudate and a cooling die that is provided on a downstream side of the extrusion machine in an extrusion direction, internally includes a flow path through which the extrudate moves, and cools the extrudate that moves in the flow path,
wherein a shredding unit is provided at a downstream end portion of the flow path of the cooling die in a moving direction of the extrudate,
the shredding unit occupies at least a portion of a cross section of the flow path taken along a direction perpendicular to the moving direction, and includes a plurality of through holes that extend through the shredding unit in the moving direction, and
the extrudate is shredded as a result of the extrudate passing through the plurality of through holes.

4. Meat-like food comprising a densely integrated product of the fibrous meat-like food according to claim 1.

5. The meat-like food according to claim 4,
wherein the fibrous meat-like food comprises at least one selected from fibrous meat-like food with a fiber thickness of 0.10 to 0.50 mm, fibrous meat-like food with a fiber thickness of 0.51 to 0.74 mm, and fibrous meat-like food with a fiber thickness of 0.75 to 1.00 mm.

6. The meat-like food according to claim 4, comprising a binder for binding fibrous strands of the fibrous meat-like food.

7. The meat-like food according to claim 4, comprising a coating film that covers the densely integrated product.

8. A method for producing meat-like food, wherein the meat-like food is according to claim 4, the method comprising:
an integration step of densely integrating a raw material that contains the fibrous meat-like food.

9. The method for producing meat-like food according to claim 8,
wherein, in the integration step, the raw material is compression molded.

10. The method for producing meat-like food according to claim 8,
wherein the raw material contains a binder for binding fibrous strands of the fibrous meat-like food, and
in the integration step, the raw material is subjected to a heat treatment.
